(19) United States
(12) Patent Application Publication
(10) Pub. No.: US 2026/0281984 A1
(43) Pub. Date: Sep. 17, 2026

(54) SYSTEMS, APPARATUSES, METHODS, AND NON-TRANSITORY COMPUTER-READABLE STORAGE MEDIA FOR WIRELESS COMMUNICATIONS EMPLOYING MULTI-LINK IN-DEVICE COEXISTENCE UNAVAILABILITY REPORTING

(71) Applicant: HUAWEI TECHNOLOGIES CO., LTD., Shenzhen (CN)

(72) Inventors: Mahmoud Hasabelnaby, Kelowna, CA (US); Osama Aboul-Magd, Kanata (CA); Jung Hoon Suh, Kanata (CA); Yan Xin, Kanata (CA); Sara Norouzi, Vancouver (CA); Abdalla Mohamed Abdelaziz Mahmoud Hssein, Ottawa (CA)

(21) Appl. No.: 19/363,029

(22) Filed: Oct. 20, 2025

Related U.S. Application Data
(60) Provisional application No. 63/773,122, filed on Mar. 17, 2025.

(51) Int. Cl. H04W 72/0446; H04W 76/15

(52) U.S. Cl. CPC H04W 72/0446; H04W 76/15

(57) ABSTRACT

A communication method has the steps of transmitting or receiving a first frame for indicating one or more unavailability time periods of a plurality of links; and accordingly, receiving or transmitting a plurality of data frames via the plurality of links using the one or more unavailability time periods.

### CROSS-REFERENCE TO RELATED APPLICATION

This application claims the benefit of U.S. Provisional Patent Application Ser. No. 63/773,122, filed Mar. 17, 2025, the content of which is incorporated herein by reference in its entirety.

### TECHNICAL FIELD

The present disclosure relates generally to communication systems, apparatuses, methods, and non-transitory computer-readable storage devices, and in particular, to systems, apparatuses, methods, and non-transitory computer-readable storage devices for wireless communication employing multi-link in-device coexistence unavailability reporting.

### BACKGROUND

Wireless communication systems such as IEEE 802.11 series (that is, WI-FI® series; WI-FI is a registered trademark of WI-FI Alliance, Austin, TX, USA) are known. In IEEE 802.11 series, the rapid adoption of Multi-Link Operation (MLO) in WI-FI® 7 necessitates an extension of these mechanisms to Multi-Link Devices (MLDs) in WI-FI® 8. MLO enables devices to simultaneously utilize multiple frequency bands, ranging from traditional sub-7.25 gigahertz (GHz) unlicensed bands (such as the 2.4 GHz to 7.25 GHz range) to higher-frequency bands from 42 GHz to 71 GHz. This wide range of frequencies opens up new opportunities for improving transmission efficiency, especially in environments with high interference or congestion.

To maximize the benefits of MLO, it is important to extend the unavailability reporting and power-saving features introduced in 11bn to MLDs.

### SUMMARY

The present disclosure provides communication methods and apparatuses.

According to a first aspect, a method is described. The method may be applied at a terminal side, for example, a STA or a module in a STA, a circuit or a chip (for example, a modem chip, also referred to as a baseband chip), or a system on chip (SoC) chip or a system in package (SIP) chip that includes a modem core that is responsible for a communication function in a STA. In the method, the STA receiving, from the AP, a first request frame (also referred to as a second frame in the present disclosure) for obtaining unavailability time periods of a plurality of links of the STA; and transmitting a first response frame (also referred to as a first frame in the present disclosure) to the AP, the first response frame including a first field indicative of unavailability time periods of at least some links among the plurality of links.

According to a second aspect, a method is described. The method may be applied to a network side, for example, an AP or a component (for example, a circuit, a chip, or a chip system) in an AP. In the method, the AP determines a first request frame for obtaining unavailability time periods of a plurality of links of the STA; and receiving a first response frame from the STA, the first response frame including a first field indicative of unavailability time periods of at least some links among the plurality of links.

In some possible implementations, the first field may be or include an Associated Identifier (AID) Traffic Identifier (TID) information field, and the AID TID information field is used for indicating the first field to indicate the unavailability time periods of the at least some links.

In some possible implementations, the AID TID information field includes: an AID 11 field, an acknowledge (ACK) type field, and a TID field, the AID 11 field is indicative of an associated identifier of the STA; the ACK type field and the TID field are used together for indicating the first field to indicate the unavailability time periods of the at least some links.

In some possible implementations, the first field includes: a Block ACK Starting Sequence field including: a type field indicative of multi-link feedback; and a sub-type field indicative of multi-link coexistence unavailability; and a Block ACK bitmap field including: a field indicative of an identifier of each link of the at least some links; and a field indicative an unavailability time period of each link of the at least some links.

In some possible implementations, the Block ACK Starting Sequence field further includes: a sub-type field indicative of multi-link power save; and/or a sub-type field indicative of multi-link adaptation.

In some possible implementations, the first field includes: a Block ACK Starting Sequence field including a type field indicative of multi-link coexistence unavailability; and a Block ACK bitmap field including: a field indicative of an identifier of each link of the at least some links; and a field indicative an unavailability time period of each link of the at least some links.

In some possible implementations, the first field includes: a Block ACK Starting Sequence field including: a type field indicative of coexistence unavailability; and a sub-type field indicative of multi-link feedback; and a Block ACK bitmap field including: a field indicative of an identifier of each link of the at least some links; and a field indicative an unavailability time period of each link of the at least some links.

In some possible implementations, the field indicative an unavailability time period of each link of the at least some links includes: a length field indicative of a length of information related to an identifier of the link; a field indicative of start time of the unavailability time period; and a field indicative of duration of the unavailability time period.

In some possible implementations, further including: transmitting, a second request frame for indicating association with the STA; and receiving, a second response frame from the AP, the second response frame including a second field indicative of support of dynamic reporting of the unavailable time periods of the plurality of links.

In some possible implementations, the second field is present in a Multi-link Device (MLD) Capabilities And Operations sub-field.

In some possible implementations, the first request frame is an initial control frame (ICF), and the first response frame is an initial control response (ICR) frame.

In some possible implementations, the first response frame includes a second field indicative of support of dynamic reporting of the unavailable time periods of the plurality of links.

In some possible implementations, the first response frame further includes a third field for ACK of the first request frame.

In some possible implementations, the third field further includes: an AID TID information field including: an AID 11 field indicative of an associated identifier of the STA; an ACK type field indicative of a type field for ACK of receiving the first request frame; and a TID field indicative of an identifier of traffic data.

According to third aspect, a communication apparatus is provided. The communication apparatus has a function of implementing any one of the first or second aspects or possible implementations thereof. For example, the communication apparatus includes a corresponding module, unit, or means (means) for performing operations in the first aspect. The module, unit, or means may be specifically implemented by using software, may be implemented by using hardware, or may be implemented by using software in combination with hardware.

According to fourth aspect, a communication apparatus is provided. The communication apparatus includes one or more processors coupled with a memory. The memory is configured to store a part or all of a necessary computer program or instructions for implementing a function in any one of the first or second aspects. The one or more processors may execute the computer program or the instructions, and when the computer program or the instructions is/are executed, the communication apparatus is enabled to implement the method in any possible design or implementation of any one of the first or second aspects or possible implementations thereof.

In some possible implementations, the communication apparatus may further include an interface circuit, and the processor is configured to communicate with another apparatus or component through the interface circuit.

In some possible implementations, the communication apparatus may further include the memory.

The communication apparatus may be an AP, a module in an AP, or a chip responsible for a communication function in an AP, for example, a modem chip (also referred to as a baseband chip) or an SoC chip or an SIP chip that includes a modem module.

According to a fifth aspect, a communication system is described, which includes the STA as described in the first aspect and the AP as described in the second aspect.

According to a sixth aspect, a computer-readable storage medium is provided. The computer-readable storage medium stores computer-readable instructions, and when a computer reads and executes the computer-readable instructions, the computer is enabled to perform the method in any one of the possible implementations of the first aspect or the second aspect.

According to a seventh aspect, a computer program product is provided. When a computer reads and executes the computer program product, the computer is enabled to perform the method in any one of the possible designs of the first aspect or the second aspect or possible implementations thereof.

According to one aspect of this disclosure, there is provided a communication method comprising: transmitting or receiving a first frame for indicating one or more unavailability time periods of a plurality of links; and accordingly, receiving or transmitting a plurality of data frames via the plurality of links using at least one of the one or more unavailability time periods.

In some implementations, the communication method is performed by a first multi-link device (MLD); the plurality of links are between the first MLD and a second MLD; and one of the first and second MLDs is an access point (AP) MLD comprising a plurality of APs, and the other one of the first and second MLDs is a station (STA) MLD comprising a plurality of STAs, and the plurality of links being formed between the plurality of APs and the plurality of STAs.

In some implementations, the method further comprises: transmitting or receiving a second frame for requesting the one or more unavailability time periods.

In some implementations, the first frame is carried via one of the plurality of links.

In some implementations, the first frame is carried through a sub-7.25 gigahertz (GHz) frequency band.

In some implementations, at least one of the plurality of links is in a millimeter-wave (MMW) frequency band.

In some implementations, the first frame is a multi-STA block acknowledgement (multi-STA Block ACK) frame conveying control or feedback information including the one or more unavailability time periods.

In some implementations, the first frame comprises a Per Associated Identifier (AID) Traffic Identifier (TID) Info field indicating the one or more unavailability time periods.

In some implementations, the Per AID TID info field comprises an acknowledge (ACK) Type field and a TID field; and values of the ACK Type field and the TID field indicate that the Per AID TID Info field is for conveying the control or feedback information.

In some implementations, the ACK Type field has a value of zero and the TID field has a value of 13 for indicating that the Per AID TID Info field is for conveying the control information or feedback.

In some implementations, the Per AID TID info field comprises an AID TID Info field; and the AID TID Info field comprises an AID11 field, the ACK Type field, and the TID field.

In some implementations, the AID11 field has a value greater than 2007.

In some implementations, the AID TID Info field has a length of two bytes, the AID11 field includes first 11 bits of the AID TID Info field, followed by the ACK Type field of one bit and subsequently the TID field of four bits.

In some implementations, the AID TID Info field has a length of two bytes, the AID11 field has a length of 11 bits, the ACK Type field has a length of one bit, and the TID field has a length of four bits.

In some implementations, the Per AID TID info field comprises a Type field indicating that the type of the control or feedback information is multi-link feedback, or indicating that the type of the control or feedback information is multi-link coexistence unavailability, or indicating that the type of the control or feedback information is coexistence unavailability.

In some implementations, the Type field has a value of two or three for indicating that the type of the control or feedback information is the multi-link feedback, or has a value of two or three for indicating that the type of the control or feedback information is the multi-link coexistence unavailability, or has a value of zero for indicating that the type of the control or feedback information is the coexistence unavailability.

In some implementations, the Per AID TID info field comprises a Sub-Type field; and the Type field indicates that the type of the control or feedback information is the multi-link feedback and the Sub-Type field indicates that the type of multi-link feedback is multi-link coexistence unavailability, or the Type field indicates that the type of the control or feedback information is the coexistence unavailability and the Sub-Type field indicates that the coexistence unavailability is single-link coexistence unavailability or multi-link coexistence unavailability.

In some implementations, the Sub-Type field has a value of zero to indicate that the type of multi-link feedback is the multi-link coexistence unavailability; or the Sub-Type field has a value of zero to indicate that the type of link feedback is single-link coexistence unavailability, or a value of one to indicate that the type of link feedback is the multi-link coexistence unavailability.

In some implementations, the Per AID TID info field comprises a Number of Links field indicating a number of the plurality of links.

In some implementations, the Per AID TID info field comprises a Block Ack Starting Sequence Control field; the Block Ack Starting Sequence Control field comprises a Starting Sequence Number field; the Starting Sequence Number field comprises the Type field and a Type-Specific Control Info field; and the Type-Specific Control Info field comprises the Number of Links field.

In some implementations, the Type-Specific Control Info field comprises the Sub-Type field.

In some implementations, the Block Ack Starting Sequence Control field has a length of two bytes, the Starting Sequence Number field has a length of 12 bits, the Type field has a length of four bits; the Type-Specific Control Info field has a length of eight bits, and the Number of Links field has a length of four bits.

In some implementations, the Sub-Type field indicates that the type of multi-link feedback is multi-link coexistence unavailability and has a length of three bits, or the Sub-Type field indicates that the coexistence unavailability is single-link coexistence unavailability or multi-link coexistence unavailability, and has a length of one bit.

In some implementations, the Per AID TID info field comprises a Block Ack Bitmap field conveying the control or feedback information including the one or more unavailability time periods.

In some implementations, the Block Ack Starting Sequence Control field comprises a Fragment Number field for indicating a length of the control or feedback information included in the Block Ack Bitmap field.

In some implementations, the Block Ack Bitmap field has a length of four, eight, 16, 32, 64, or 128 bytes, and the Fragment Number field has a length of four bits.

In some implementations, the first frame comprises a Multi-Link Element conveying the one or more unavailability time periods, the Multi-Link Element being a Basic Multi-Link Element or a Multi-Link Reconfiguration Element.

In some implementations, the first frame is a link (re)configuration request frame, a link (re)configuration response frame, or a link (re)configuration notify action frame.

In some implementations, a MLD Capabilities And Operations subfield or an Extended MLD Capabilities And Operations subfield of a Common Info field of the Multi-Link Element comprises a Dynamic Unavailability Operation (DUO) Support field indicating that the one or more unavailability time periods are allowed to report.

In some implementations, the DUO Support field has a length of one bit.

In some implementations, the DUO Support field is the 15th bit of the MLD Capabilities And Operations subfield of the Common Info field of the Multi-Link Element, or is the eighth bit of the Extended MLD Capabilities And Operations subfield of the Common Info field of the Multi-Link Element.

In some implementations, a STA Control field of the Multi-Link Element comprises a DUO Present field indicating the presence of DUO support.

In some implementations, the Multi-Link Element is a Multi-Link Reconfiguration Element; and wherein the STA Control field of the Multi-Link Reconfiguration Element comprises a Reconfiguration Operation Type field for indicating that the first frame is a feedback for reporting the one or more unavailability time periods.

In some implementations, the Reconfiguration Operation Type field has a value of five for indicating that the first frame is the feedback for reporting the one or more unavailability time periods.

In some implementations, the STA Control field of the Multi-Link Reconfiguration Element has a length of two bytes, the Reconfiguration Operation Type field has a length of four bits, and the DUO Present field comprises one of the last two bits of the Multi-Link Reconfiguration Element.

In some implementations, a STA Info field of the Multi-Link Element comprises the one or more unavailability time periods.

According to one aspect of this disclosure, there is provided a communication apparatus configured to perform any of the above-described methods.

According to one aspect of this disclosure, there is provided a communication apparatus comprising: one or more processors functionally coupled to one or more non-transitory computer-readable storage media; wherein the one or more non-transitory computer-readable storage media stores computer-executable instructions; and wherein the instructions, when executed by the one or more processors, cause the apparatus to perform any of the above-described methods via a wireless communication interface.

According to one aspect of this disclosure, there is provided one or more non-transitory computer-readable storage media comprising computer-executable instructions, wherein the instructions, when executed by one or more processors, cause an apparatus to perform any of the above-described methods via a wireless communication interface.

According to one aspect of this disclosure, there is provided a computer program product for storing instructions which, when executed, cause an apparatus to perform any of the above-described methods.

According to one aspect of this disclosure, there is provided one or more processors functionally coupled to one or more non-transitory computer-readable storage media, wherein the one or more non-transitory computer-readable storage media comprise computer-executable instructions; and wherein the instructions, when executed, cause the one or more processors to perform any of the above-described methods.

According to one aspect of this disclosure, there is provided an apparatus for performing any of above-described methods and their implementations. Specifically, the apparatus includes one or more units for performing any of above-described methods and their implementations.

According to one aspect of this disclosure, there is provided a computer program. When the computer program is executed by a computer, an apparatus is enabled to implement the any of above-described methods and their implementations.

According to one aspect of this disclosure, there is provided a communication system. The communication system includes a first communication-node and/or a second communication-node, the first communication-node is configured to perform any of the above-described methods regarding with the first communication-node as stated above, and the second communication-node is configured to perform any of the above-described methods regarding with the second communication-node as stated above.

The methods (and related processors, apparatuses, systems, computer-readable storage media, and/or the like) disclosed herein have various advantages and technical benefits.

For example, the methods disclosed herein enable non-AP STA MLDs to report unavailability across multiple links, thereby improving coordination of transmission windows and reducing unnecessary retransmissions, and enhancing reliability. The methods disclosed herein use enhanced transmission scheduling and conflict resolution, which improves transmission efficiency by managing transmission opportunities (TXOP) across multiple links, thereby reducing conflicts and retransmissions, and enhancing overall network performance. Moreover, the methods disclosed herein provide scalability and flexibility across frequency bands, which ensure scalable mechanisms across both lower-frequency bands (such as sub-7.25 GHz bands) and higher-frequency bands (such as 42 GHz to 71 GHZ), thereby supporting future WI-FI® developments and improving performance across diverse environments.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing a three-link Multi-Link Operation (MLO) connection between an AP Multi-link Device (MLD) and an STA MLD with certain links having unavailable periods; according to some embodiments of this disclosure;

FIG. 5 is a schematic diagram showing the structure of a multi-STA Block Ack frame for multi-link feedback, according to some embodiments of this disclosure, wherein the multi-Link feedback may be conveyed within one of the Per AID TID Info fields of the multi-STA BA frame;

FIG. 6 is a schematic diagram showing the format of the AID TID info subfield of the Per AID TID Info field shown in FIG. 5, according to some embodiments of this disclosure;

FIG. 7 is a schematic diagram showing the format of the Block Ack Starting Sequence Control subfield of the Per AID TID Info field shown in FIG. 5, according to some embodiments of this disclosure;

FIG. 8 is a schematic diagram showing the format of the Block Ack Starting Sequence Control subfield shown in FIG. 7, according to some embodiments of this disclosure;

FIG. 9 a schematic diagram showing the format of the Block ACK Bitmap subfield of the Per AID TID Info field shown in FIG. 5, according to some embodiments of this disclosure;

FIG. 10 is a schematic diagram summarizing the details of the structure of the Per AID TID Info field shown in FIG. 5 adapted to carry multilink feedback, according to some embodiments of this disclosure;

FIG. 11 is a schematic diagram showing the structure of the Per AID TID Info field shown in FIG. 5 adapted to carry multilink feedback, according to some other embodiments of this disclosure;

FIG. 12 is a schematic diagram showing the structure of the Per AID TID Info field shown in FIG. 5 adapted to carry multilink feedback, according to yet some other embodiments of this disclosure;

FIG. 13 is a schematic diagram showing the structure of the Per AID TID Info field shown in FIG. 5 adapted to carry Coexistence Unavailability feedback, according to some embodiments of this disclosure;

FIG. 14 is a schematic diagram showing the structure of the Per AID TID Info field shown in FIG. 5 adapted to carry Coexistence Unavailability feedback, according to some other embodiments of this disclosure;

FIG. 15 is a schematic diagram showing the structure of the Common Info field of a Basic Multi-Link Element, according to some embodiments of this disclosure;

FIG. 16 is a schematic diagram showing the structure of the conventional MLD Capabilities and Operations subfield of the Common Info field of the Basic Multi-Link Element;

FIG. 17 is a schematic diagram showing the structure of the MLD Capabilities and Operations subfield of the Common Info field of the Basic Multi-Link Element shown in FIG. 15, according to some embodiments of this disclosure;

FIG. 18 is a schematic diagram showing the structure of the conventional Extended MLD Capabilities and Operations subfield of the Common Info field of the Basic Multi-Link Element;

FIG. 19 is a schematic diagram showing the structure of the Extended MLD Capabilities and Operations subfield of the Common Info field of the Basic Multi-Link Element shown in FIG. 15, according to some embodiments of this disclosure;

FIG. 20 is a schematic diagram showing the structure of the conventional STA control field of the Basic Multi-Link Element;

FIG. 21 is a schematic diagram showing the structure of the STA Control field of the Basic Multi-Link Element, according to some embodiments of this disclosure;

FIG. 22 is a schematic diagram showing the structure of the STA Info field format of the Basic Multi-Link Element, according to some embodiments of this disclosure

FIG. 23 is a schematic diagram showing the structure of the Common Info field of a Reconfiguration Multi-Link Element, according to some embodiments of this disclosure.

FIG. 24 is a schematic diagram showing the structure of the conventional STA Control field format of the Reconfiguration Multi-Link Element;

FIG. 25 is a schematic diagram showing the structure of the STA Control field of the Reconfiguration Multi-Link Element, according to some embodiments of this disclosure; and

FIG. 26 is a schematic diagram showing the structure of the STA Info field of the Reconfiguration Multi-Link Element, according to some embodiments of this disclosure.

### DETAILED DESCRIPTION

Numerous details are described herein to provide a thorough understanding of the example implementations illustrated in the accompanying drawings. However, some implementations may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the implementations described herein.

### A. System Structure

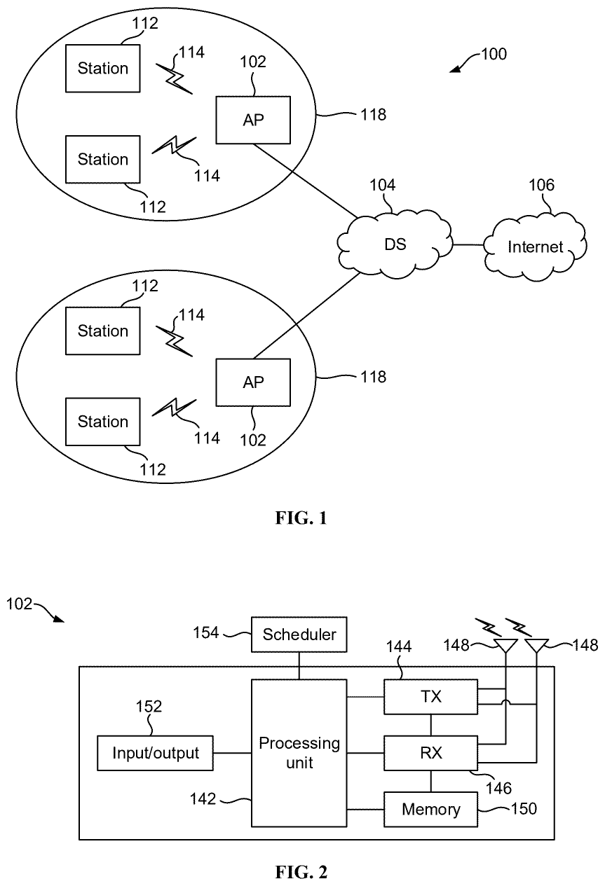

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (denoted non-AP STAs or simply STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises a processing structure 142, a wireless communication interface, at least one memory 150, and one or more input/output components or interfaces 152, wherein the wireless communication interface may comprise necessary components, such as at least one transmitter (TX) 144, at least one receiver (RX) 146, one or more antennas 148, and/or the like, for wireless communication with one or more other wireless communication devices. Sometimes, a TX 144 and a RX 146 may be collectively referred to as a transceiver, and may be integrated into a single component in some embodiments.

A scheduler 154 may be coupled to the processing structure 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing structure 142 is configured for performing various processing operations such as signal coding, data processing, power control, input/output processing, or any other suitable functionalities. The processing structure 142 may comprise one or more processors such as one or more microprocessors, one or more microcontrollers, one or more digital signal processors, one or more Field Programmable Gate Arrays (FPGAs), one or more Application-Specific Integrated Circuits (ASICs), and/or the like. In some embodiments, the processing structure 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing structure 142 and data used, generated, or collected by the processing structure 142. For example, the memory 150 may store instructions of software, software systems, or software modules that are executable by the processing structure 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

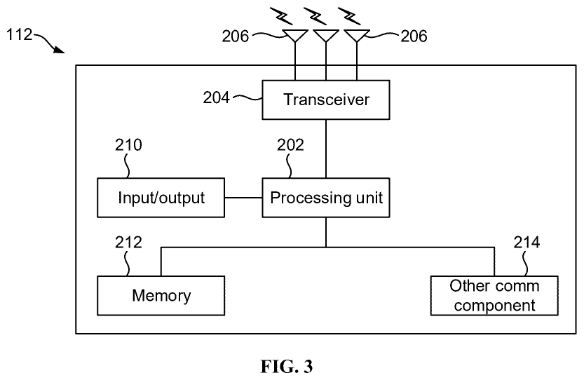

FIG. 3 is a simplified schematic diagram of a STA 112. As shown, the STA 112 comprises a processing structure 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing structure 202 is configured for performing various processing operations such as signal coding, data processing, power control, input/output processing, or any other functionalities to enable the STA 112 to access and join the communication system 100 and operate therein. The processing structure 202 may also be configured to implement some or all of the functionalities of the STA 112 described in this disclosure. The processing structure 202 may comprise one or more processors such as one or more central processing units (CPUs), one or more microprocessors, one or more microcontrollers, one or more digital signal processors, one or more accelerators, one or more graphic processing units (GPUs), one or more tensor processing units (TPU), one or more FPGAs, one or more ASICs, and/or the like. Examples of the processing structure 202 may be one or more ARM® microprocessors (ARM is a registered trademark of Arm Ltd., Cambridge, UK) manufactured by a variety of manufactures such as Qualcomm of San Diego, California, USA, under the ARM® architecture, one or more INTEL® microprocessors (INTEL is a registered trademark of Intel Corp., Santa Clara, CA, USA), one or more AMD® microprocessors (AMD is a registered trademark of Advanced Micro Devices Inc., Sunnyvale, CA, USA), and/or the like. In some embodiments, the processing structure 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 are configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing structure 202 and data used, generated, or collected by the processing structure 202. For example, the memory 212 may store instructions of software, software systems, or software modules that are executable by the processing structure 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### Wireless Communication Employing Multi-Link In-Device Coexistence Unavailability Reporting

One of the most transformative features introduced in IEEE 802.11be (WI-FI® 7) is Multi-Link Operation (MLO), which allows devices to operate on multiple frequency bands and/or channels simultaneously. This capability promises to improve network performance by increasing throughput, reducing latency, enhancing reliability, and/or the like, particularly in challenging environments with high interference or congestion. A device with MLO capability is generally denoted a Multi-link Device (MLD), which comprises a plurality of link components such as a plurality of transmitters (Tx), a plurality of receivers (Rx), or a plurality of transceivers (wherein a transceiver is a combination of a Tx and an Rx), such that the MLD may simultaneously communicate with one or more other devices (such as one or more other MLDs, a plurality of single-link devices, and/or the like) via a plurality links in a plurality of frequency bands and/or channels. For example, an AP MLD may comprise a plurality of link components, each of which may be considered an affiliated AP 102. Similarly, a non-AP STA MLD may comprise a plurality of link components, each of which may be considered an affiliated non-AP STA 112.

In tandem with these advancements, the IEEE 802.11bn standard (WI-FI® 8) has been evolving to address the growing demand for more efficient and adaptive network management, especially in scenarios where WI-FI® devices may need to update their transmission parameters to enhance their reliability, to balance performance with power consumption, or when becoming temporarily unavailable due to participation in other non-WI-FI activities, such as those related to Bluetooth® or Global Positioning System (GPS). One such area of focus is the enhancement of link adaptation, power-saving mechanisms, and the management of dynamic unavailability in devices (wherein examples of dynamic unavailability include an STA being unavailable to transmit and/or receive due to high in-device interference, or during the declared unavailability periods, the STA being unavailable to TX/RX due to other in-device coexistence interference activities such as activities related to Bluetooth®, GPS, radar, and/or the like), which are important for optimizing both power consumption and transmission reliability in real-world applications.

The recent approval of several motions under the IEEE 802.11bn task group has laid the groundwork for improving power-saving mechanisms and in-device coexistence unavailability reporting (also simply denoted “dynamic unavailability operation (DUO) reporting”, which is also denoted herein as “Multi-Link Unavailability Reporting”) for single-link operation. These efforts are aimed at enhancing the ability of non-AP STAs 112 to report unavailability at the Transmission Opportunity (TXOP) level, as well as to define or update mechanisms for reporting long-term, periodic unavailability, according to Motion #30. This will allow for better coordination of transmission windows, reduce unnecessary retransmissions, and improve overall reliability in single-link scenarios.

Additionally, Motion #9 introduced a power-saving mode for ultra-high reliability (UHR) devices such as mobile APs 102 or non-AP STAs 112. This mode allows devices to transition from a lower capability mode to a higher capability mode upon reception of an initial control frame, providing more efficient use of available resources while still maintaining a high level of performance when needed.

While these motions and contributions are a significant step forward for single-link operation, the rapid adoption of MLO in WI-FI® 7 necessitates a solution for applying these mechanisms to MLDs in, for example, WI-FI® 8, and/or similar standards and technologies. MLO enables devices to simultaneously utilize multiple frequency bands, ranging from traditional sub-7.25 gigahertz (GHz) unlicensed bands (such as the 2.4 GHz to 7.25 GHz range) to higher-frequency bands, for example, from 42 GHz to 71 GHz. This wide range of frequencies opens up new opportunities for improving transmission efficiency, especially in environments with high interference or congestion.

To maximize the benefits of MLO, it is important to find a solution to implement the unavailability reporting and power-saving features introduced in 11bn to MLDs. By supporting Multi-Link Unavailability Reporting, Multi-Link Transmit/Receive Parameter Adaptation, and/or Multi-Link Power Save mechanisms, the overall efficiency of MLO may be significantly enhanced. These extended features may allow MLDs to better coordinate their operations across multiple links, thereby improving transmission scheduling, reducing energy consumption, and enhancing the reliability of data delivery.

Thus, implementing the capabilities and features introduced in 11bn to MLDs is important for WI-FI® 8's or WI-FI® 9's MLO. Such implementation not only enhances the performance and energy efficiency of MLO but also ensures that the technology can scale effectively across both existing and emerging WI-FI® bands. As MLDs become more prevalent, the integration of robust unavailability reporting, power-saving, and link adaptation mechanisms may be important for optimizing their performance and ensuring reliable connectivity across a wide range of use cases.

The rapid evolution of WI-FI® technologies, particularly with the introduction of MLO in WI-FI® 7 and the upcoming enhancements in WI-FI® 8, presents several technical challenges that need to be addressed to fully realize the potential of these advancements. These challenges include:

⋅ Coexistence (also abbreviated as “Coex.”) and unavailability reporting across multiple links

As WI-FI® devices increasingly operate across multiple frequency bands and channels, effectively managing unavailability becomes more complex. Non-AP STAs 112 must be able to report periods of unavailability across multiple links in a manner that does not disrupt overall network performance. This includes both short-term and long-term unavailability, particularly in scenarios where devices participate in non-Wi-Fi activities (e.g., activities related to Bluetooth, GPS, and/or the like) that temporarily prevent data transmission. Existing mechanisms designed for single-link operation may not scale efficiently for MLDs, which need to coordinate transmission windows across multiple active links.

### ⋅ Scalability of Features Across Emerging Frequency Bands

With the expansion of WI-FI® operation into higher-frequency bands (such as 42 GHz to 71 GHz), new challenges arise in managing MLO efficiently. These higher-frequency bands can be more susceptible to environmental factors such as increased attenuation and interference. To fully leverage these emerging bands, WI-FI® devices need to incorporate robust mechanisms for multi-link adaptation, unavailability reporting, power saving, and/or the like that can scale across both existing and future WI-FI® bands, and/or the like.

In the following, various embodiments of wireless communication methods employing multi-link in-device coexistence unavailability reporting are described, which address these challenges by extending the unavailability reporting, power-saving mechanisms, link adaptation features introduced in IEEE 802.11bn, and/or the like, to MLDs such as MLDs in WI-FI® 8. By using the methods disclosed herein for dynamic adaptation, efficient power management, enhanced transmission scheduling across multiple links, and/or the like, the methods disclosed herein may significantly improve the reliability, energy efficiency, performance, and/or the like for WI-FI® networks in MLO scenarios, especially as they transition to operating across diverse frequency bands, including higher-frequency unlicensed bands.

The methods disclosed herein provide a comprehensive solution to the technical challenges posed by MLO in, for example, WI-FI® 7 and WI-FI® 8. The methods disclosed herein extend the existing power-saving, unavailability reporting, link adaptation mechanisms, and/or the like to MLDs, thereby ensuring that these devices can efficiently operate across multiple frequency bands and achieve improved or even optimized performance in diverse environments.

As will be described in more details below, the methods disclosed herein comprise various features in various embodiments, such as:

### ⋅ Multi-Link Unavailability Reporting

The methods disclosed herein provide an enhanced unavailability reporting signaling mechanism that allows MLDs to report their unavailability across multiple links simultaneously. This extends the unavailability reporting capabilities introduced in IEEE 802.11bn for single-link operation, ensuring that MLDs can dynamically signal periods of unavailability due to various causes such as interference, non-Wi-Fi activities (for example, activities related to Bluetooth, GPS, and/or the like), and/or the like, without causing disruption to network performance.

### ⋅ Scalability and Flexibility Across Frequency Bands

With the expanding WI-FI® ecosystem, including the use of higher-frequency unlicensed bands, the methods disclosed herein provide sufficient scalability and flexibility to operate across both existing and emerging WI-FI® bands. In some embodiments, the herein-disclosed multi-link adaptation, unavailability reporting, power-saving mechanisms, and/or the like are designed to support MLDs in all suitable frequency ranges, such as the sub-7.25 GHz bands and the higher-frequency 42 GHz to 71 GHz bands, thus ensuring that the WI-FI® network can scale efficiently as new spectrum becomes available.

Therefore, the methods disclosed herein enhance the performance, reliability, energy efficiency, and/or the like for WI-FI® networks such as WI-FI® 7 and WI-FI® 8 networks by addressing the unique challenges posed by MLO. Through advanced multi-link unavailability reporting, dynamic power-saving techniques, adaptive link adaptation, and/or advanced or even optimized transmission scheduling, the methods disclosed herein enable MLDs to operate more efficiently across multiple frequency bands, thereby ensuring reliable and high-performance connectivity in diverse environments.

In various embodiments, the methods disclosed herein may be suitable for the standardization of next generation of IEEE 802.11 for MLOs.

In various embodiments, the methods disclosed herein may be suitable for use by various devices such as WI-FI® APs 102 and STAs 112 with MLOs, such as WI-FI® 8 Multi-Link APs, future MLDs, and/or the like.

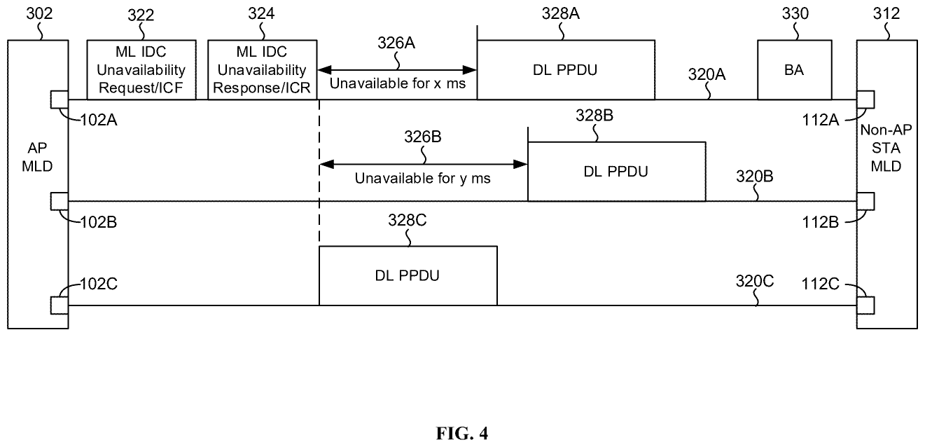

FIG. 4 is a schematic diagram showing a three-link Multi-Link Operation (MLO) connection with certain links having unavailable periods; according to some embodiments of this disclosure. In this example, the AP MLD 302 comprises three link components 102A, 102B, and 102C (for ease of description, each may be considered an AP 102), and the STA MLD 312 comprises three link components 112A, 112B, and 112C (for ease of description, each may be considered a non-AP STA 112). The AP MLD 102 is in communication with the STA MLD 112 simultaneously via three links 320A (between AP 102A and STA 112A), 320B (between AP 102B and STA 112B), and 320C (between AP 102C and STA 112C).

As shown, the AP MLD 302 transmits an Initial Control Frame (ICF) 322 to the non-AP STA MLD 312 via the link 320A requesting its unavailability period (denoted in FIG. 4 as a Multi-Link (ML) In-Device Coexistence (IDC) unavailability request, wherein IDC refers to any source of interference, including self-interference between multiple links operating on adjacent channels, as well as interference from non-Wi-Fi activities such as Bluetooth®, radar, GPS, and/or other similar sources). The non-AP STA MLD 312 responds with an Initial Control Response (ICR) frame 324 via the link 320A, indicating the unavailability period 326 for each affiliated non-AP STA 112 associated with the non-AP STA MLD 312 (including the unavailability period 326A for the link 320A, the unavailability period 326B for the link 320B, and no unavailability period for the link 320C).

The ML IDC or Coexistence Unavailability reporting allows the AP MLD 302 to optimize its downlink transmission scheduling for the non-AP STA MLD 312 based on the unavailability report per affiliated STA 112. For example, the AP MLD 302 may transmit a DL PPDU 328A via the link 320A after the corresponding unavailability period 326A (counted from the reception of the ICR frame 324), a DL PPDU 328B via the link 320B after the corresponding unavailability period 326B (counted from the reception of the ICR frame 324), and a DL PPDU 328C via the link 320C immediately after the reception of the ICR frame 324. The STA MLD 312 may send a multi-STA block acknowledgement (“BA”, “Block ACK”, or “multi-STA Block ACK”) frame 330 via, for example, link 320A after receiving the DL PPDUs 328A to 328C.

While the transmission of the ICF 322 and the ICR 324 may be through any active link, in this example, the ML IDC or Coexistence Unavailability reporting (including the transmission of the ICF 322 and the ICR 324) is transmitted using a same one of the activated links (for example, link 320A) to minimize the signaling overhead.

In some embodiments, such as in systems following IEEE 802.11bq standard, it may be preferable to transmit the Multi-Link Coexistence Unavailability feedback 324 over one of the active links operating in the sub-7.25 GHz unlicensed band (ranging from 2.4 GHz to 7.25 GHz). This can help minimize signaling overhead and increase the likelihood of successful reception, compared to transmitting it over the millimeter-wave (MMW, also denoted “mmWave”) link.

In some embodiments, the Coexistence Unavailability reports of the MMW link may be transmitted over one of the active links operating in the sub-7.25 GHz unlicensed band (ranging from 2.4 GHz to 7.25 GHZ). This increases the likelihood of successful reception, compared to transmitting it over the MMW link.

In some embodiments, the multi-STA Block ACK 330 may be suitable for conveying different multi-link feedback information (for example, Multi-Link Unavailability report, multi-link adaptation, multi-link power saving, and/or the like). In some embodiments, the multi-STA BA frame 330 may include a Block Ack bitmap if the preceding PPDU 328A, 328B, and/or 328C includes quality of Service (QoS) data frame(s) that solicit an immediate response (e.g., Ack or Block Ack context). The multi-STA BA frame 330 may also or alternatively include feedback information when the non-AP STA MLD 312 is operating in a mode that allows inclusion of feedback information (for example, Multi-Link Coexistence unavailability reports).

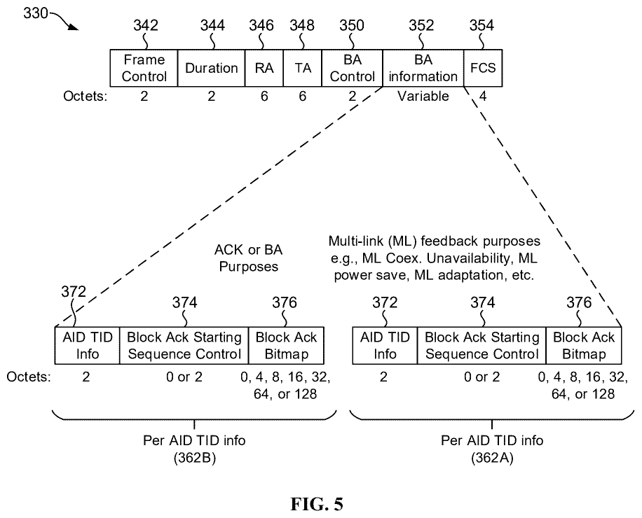

FIG. 5 is a schematic diagram showing the structure of the multi-STA BA frame 330 for multi-Link feedback such as a Multi-Link Coexistence Unavailability report, multi-link adaptation, multi-link power saving feedback information, and/or the like, according to some embodiments of this disclosure, wherein the multi-Link feedback may be conveyed within one of the Per AID TID Info fields of the multi-STA BA frame 330 (wherein “AID” refers to “Associated Identifier” and “TID” refers to “Traffic Identifier”).

As shown, the multi-STA BA frame 330 in this example comprises a two-byte Frame Control field 342, a two-byte Duration field 344, a six-byte Receiver Address (RA) field 346, a six-byte Transmitter Address (TA) field 348, a BA Control field 350, a BA Information field 352 of a variable size, and a four-byte Frame Check Sequence (FCS) field 354.

The multi-STA BA frame 330 allows for a plurality of Per AID TID Info subfields 362 to be included in the BA Information field 352. By using the Per AID TID Info subfields 362, the multi-STA BA frame 330 may carry various multi-link feedback such as multi-link Coexistence Unavailability report, multi-link adaptation, multi-link power saving feedback information, and/or the like.

In the example shown in FIG. 5, the BA Information field 352 comprises two Per AID TID Info subfields 362A and 362B, with one Per AID TID Info subfield 362A conveying the multi-Link solicited or unsolicited feedback, such as the Multi-Link Coexistence Unavailability report, multi-link adaptation, multi-link power saving feedback information, and/or the like, and the other Per AID TID Info subfield 362B designated for acknowledging the multi-link feedback request or initial control frame sent by the AP MLD 302.

As shown in FIG. 5, each Per AID TID Info subfield 362 comprises a two-byte AID TID Info subfield 372, and may optionally further comprise a two-byte Block Ack Starting Sequence Control subfield 374, and a Block Ack Bitmap subfield 376 having a length of four, eight, 16, 32, 64, or 128 bytes.

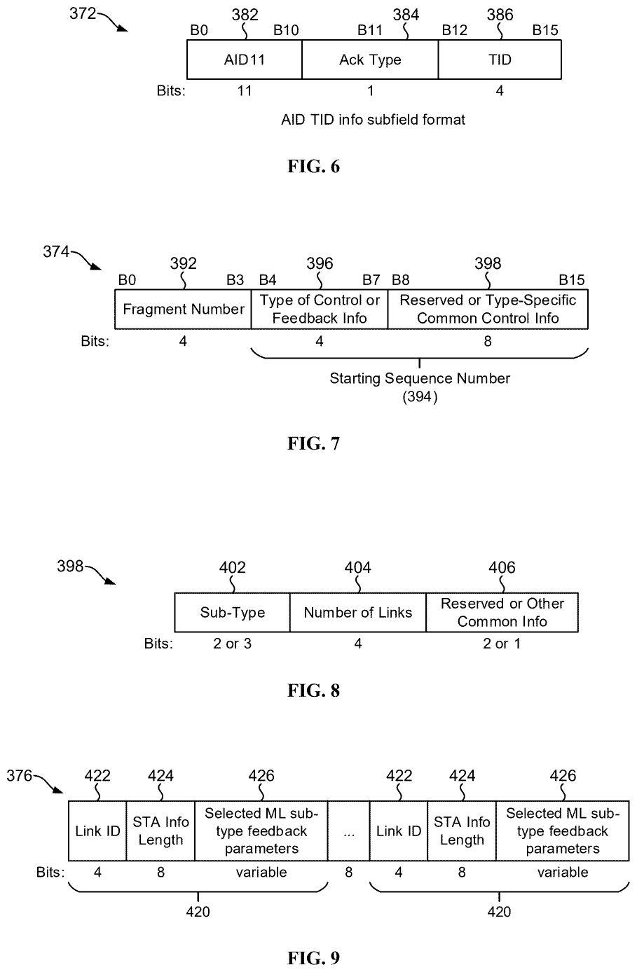

FIG. 6 is a schematic diagram showing the format of the AID TID Info subfield 372, according to some embodiments of this disclosure. As shown, in these embodiments, 11 bits of the AID TID Info subfield 372 (for example, bits B0, B1, . . . , B10; denoted the AID11 subfield 382) are used for indicating the AID, one (1) bit of the AID TID Info subfield 372 (for example, bit B11; denoted the ACK Type subfield 384) is used for indicating Ack Type, and four (4) bits (for example, bits B12, B13, . . . , B15; denoted the TID subfield 386) are used for indicating the TID.

The non-AP STA MLD 312 may set the value of the AID11 subfield 382 to the value of the AID of the AP MLD 302. In some embodiments, any special AID greater than 2007 may also be used as an identification for this special Per AID TID Info field 362.

The one-bit ACK Type subfield 384 and the four-bit TID subfield 386 may be combined for indicating if this Per AID TID Info subfield 362 is sent for Ack or BA (that is, being the Per AID TID Info subfield 362B), or other feedback/control information (that is, being the Per AID TID Info subfield 362A).

According to the Draft P802.11bn/D0.1, the combination of the Ack Type subfield 384 having a value of zero (0) and the TID subfield 386 having a value of 13 is used to indicate the intended use of the Per AID TID Info subfield 362 for conveying feedback.

In some embodiments, the combination of the Ack Type subfield 384 having a value of zero (0) and the TID subfield 386 having a value of 13 is used to indicate the intended use of the Per AID TID Info subfield 362 for conveying control information or feedback as shown in TABLE 1. In other words, TABLE 1 below revised the corresponding table in Draft P802.11bn/D0.1 by defining Ack Type subfield value of zero (0) and the TID subfield value of 13 (which is a reserved combination in Draft P802.11bn/D0.1) as the indication of the presence of Block Ack Starting Sequence Control subfield 374 and Block Ack Bitmap subfield 376 in the corresponding Per AID TID info subfield 362, and the context of the corresponding Per AID TID Info subfield 362 is Feedback and/or Control information.

TABLE 1

| | | Presence of Block | |
|---|---|---|---|
| Ack | | Ack Starting | Context of a Per AID |
| Type | TID | Sequence Control | TID Info subfield in |
| subfield | subfield | subfield and Block | a Multi-STA Block Ack |
| values | values | Ack Bitmap subfields | frame |
| 0 | 0-7 | Present | Block acknowledge context: |
| | | | Sent as an acknowledgement |
| | | | to QoS Data frames that |
| | | | solicit a Block Ack frame |
| | | | response or to a BlockAckReq |
| | | | frame. |
| 1 | 0-7 | Not present | Acknowledgement context: |
| | | | Sent as an acknowledgement |
| | | | to a QoS Data or QoS Null |
| | | | frame that solicits an Ack |
| | | | frame response. |
| 0 or 1 | 8-12 | N/A | Reserved |
| 0 | 13 | Present | Feedback/Control info |
| 1 | 13 | N/A | Reserved |
| 0 | 14 | N/A | Reserved |
| 1 | 14 | Not present | All ack context: |
| | | | Sent as an acknowledgement |
| | | | to an A-MPDU that contains |
| | | | an MPDU that solicits an |
| | | | immediate response and all |
| | | | MPDUs contained in the |
| | | | A-MPDU are received |
| | | | successfully. |
| 0 | 15 | N/A | Reserved |
| 1 | 15 | Not present | Management/PS-Poll frame |
| | | | acknowledgement context: |
| | | | Sent as an acknowledgement |
| | | | to a Management or PS-Poll |
| | | | frame. |

In some embodiments, other reserved values of the Ack Type and TID subfields may also be repurposed for carrying the Multi-Link solicited or unsolicited feedback, such as Multi-Link Coexistence Unavailability report, multi-link adaptation, multi-link power saving feedback information, and/or the like.

Conventionally, the 16-bit Block ACK Starting Sequence Control subfield 374 comprises a four-bit Fragment Number for indicating the length of the Block Ack Bitmap subfield 376 in case of BA/ACK purposes, and a 12-bit Starting Sequence Number for indicating the starting sequence number in case of BA/ACK purposes.

In some embodiments as shown in FIG. 7, the 16-bit Block ACK Starting Sequence Control subfield 374 may be used for indicating the information control. More specifically, the four-bit Fragment Number 392 may be reused to indicate the length of the feedback or control information included in the Block Ack Bitmap subfield 376; four (4) bits of the 12-bit Starting Sequence Number 394 (denoted the Type subfield 396) may be reused to indicate the type of control or feedback information, and some or all of the remaining eight (8) bits of the 12-bit Starting Sequence Number subfield 394 (denoted the Type-Specific Common Control Info subfield 398) may be reserved or used to provide type-specific common control information, such as a sub-type indication or an indication of the presence of certain parameters to be included in the Block ACK Bitmap subfield 376.

In some embodiments, the Block ACK Bitmap subfield 376 is reused to include the control information parameters for the selected control information type.

TABLE 2 shows an example of the values of the Type subfield 396 located in, for example, the first four (4) bits of the Starting Sequence Number 394:

TABLE 2

| Value | Type |
|---|---|
| 0 | Coexistence Unavailability |
| 1 | Low-Latency Traffic Indication |
| 2 | Multiple Access Points (MAP) Coordination |
| 3 | Multi-Link Feedback |
| 4-15 | Reserved (which can be used for non-primary |
| | channel access (NPCA), dynamic power saving (DPS), |
| | Buffer Status Report (BSR), Link Adaptation, |
| | Intermediate FCS (IFCS), and/or the like) |

As shown in FIG. 8, if the Type subfield 396 indicates Multi-Link feedback (that is, having the value of three (3)), then, two (2) or three (3) bits of the eight-bit Type-Specific Common Control Info subfield 398 (denoted a Sub-Type subfield 402) are used to indicate the sub-type of the Multi-Link feedback (for example, Multi-Link adaptation, Multi-link Unavailability, Multi-Link dynamic power save, and/or the like), four (4) bits of the eight-bit Type-Specific Common Control Info subfield 398 (denoted a Number of Links subfield 404) are used to indicate the number of links whose information will be fed back to the AP MLD 302, and two (2) or one (1) bit of the eight-bit Type-Specific Common Control Info subfield 398 (denoted an Other Common Info subfield 406) is reserved or utilized for other common information. TABLE 3 shows some examples of the values of the Sub-Type subfield 402 and the corresponding information.

TABLE 3

| Value | Sub-Type |
|---|---|
| 0 | Multi-Link Coexistence Unavailability |
| 1 | Multi-Link Power Save |
| 2 | Multi-Link Adaptation |
| 3-7 | Reserved |

Based on the selected control or feedback information type (indicated by the Type subfield 396) and sub-type (indicated by the Sub-Type subfield 402), the Block ACK Bitmap subfield 376 is reused to include the control information parameters for the selected control or feedback information type.

As shown in FIG. 9, in some embodiments, if the selected type 396 is Multi-Link Feedback and selected sub-type 402 is Multi-Link Coexistence Unavailability, the Block ACK Bitmap subfield 376 is reused to include one or more Multi-Link Coexistence Unavailability parameters. Based on the number of links whose feedback is reported, the Block ACK Bitmap subfield 376 may comprise one or more sections 420 each corresponding to a link or an affiliated STA 112, wherein each section 420 comprises one or more of the following information:
Link ID 422 (four (4) bits): indicating which link's feedback is reported;
STA Info Length 424 (eight (8) bits): indicating the length of the feedback parameters reported for specific link; and
Selected ML sub-type feedback parameters 426 (variable length).

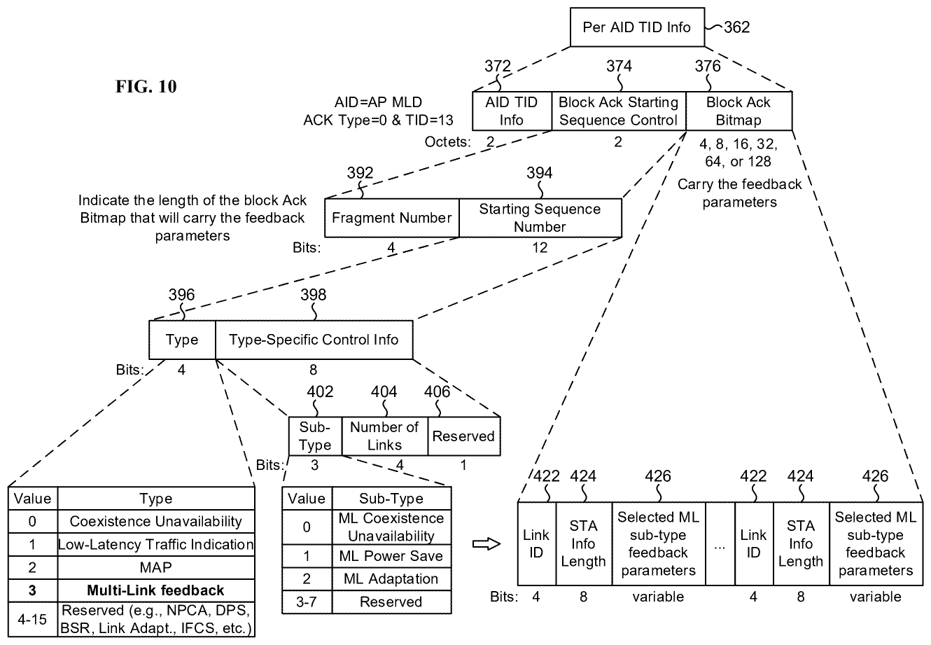

FIG. 10 is a schematic diagram summarizing the details of the structure of the Per AID TID Info field 362.

In above embodiments, the Type subfield 396 uses values zero (0) to three (3) with values four (4) to 15 reserved (which can be used for NPCA, DPS, BSR, Link Adaptation, IFCS, and/or the like); see TABLE 2. In some embodiments, the Type subfield 396 uses values zero (0) to two (2) with values three (3) to 15 reserved (which can be used for NPCA, DPS, BSR, Low-Latency Traffic indication, Link Adaptation, IFCS, and/or the like), as shown in TABLE 4.

TABLE 4

| Value | Type |
|---|---|
| 0 | Coexistence Unavailability |
| 1 | MAP Coordination |
| 2 | Multi-Link Feedback |
| 3-15 | Reserved (which can be used for NPCA, |
| | DPS, BSR, Low-Latency Traffic indication, |
| | Link Adaptation, and/or the like) |

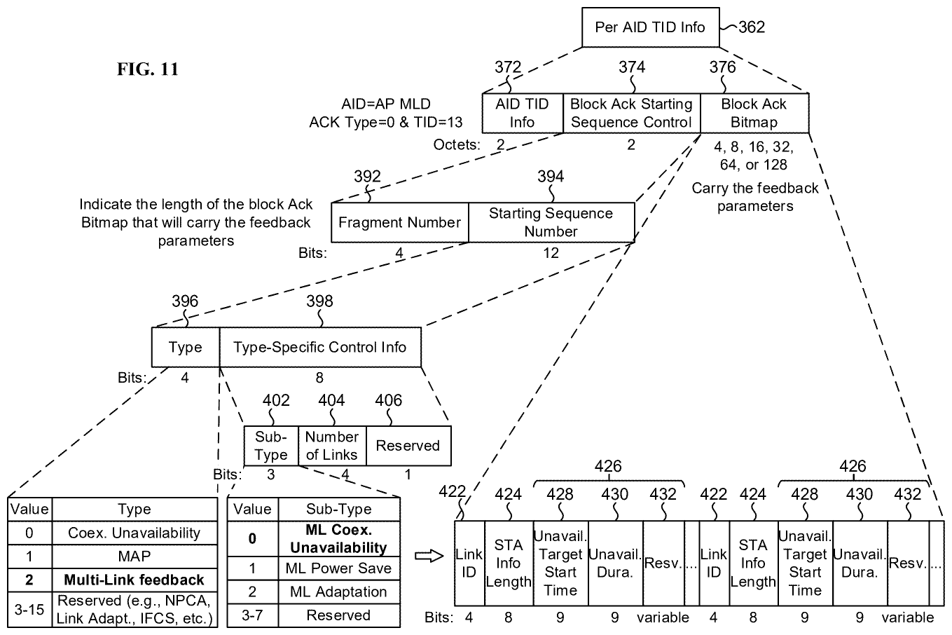

In some embodiments as shown in FIG. 11, the Selected ML sub-type feedback parameters 426 may comprise:
Unavailability Start Time 428 (nine (9) bits),
Unavailability Duration 430 (nine (9) bits), and
Other Information or reserved 432 (variable length).

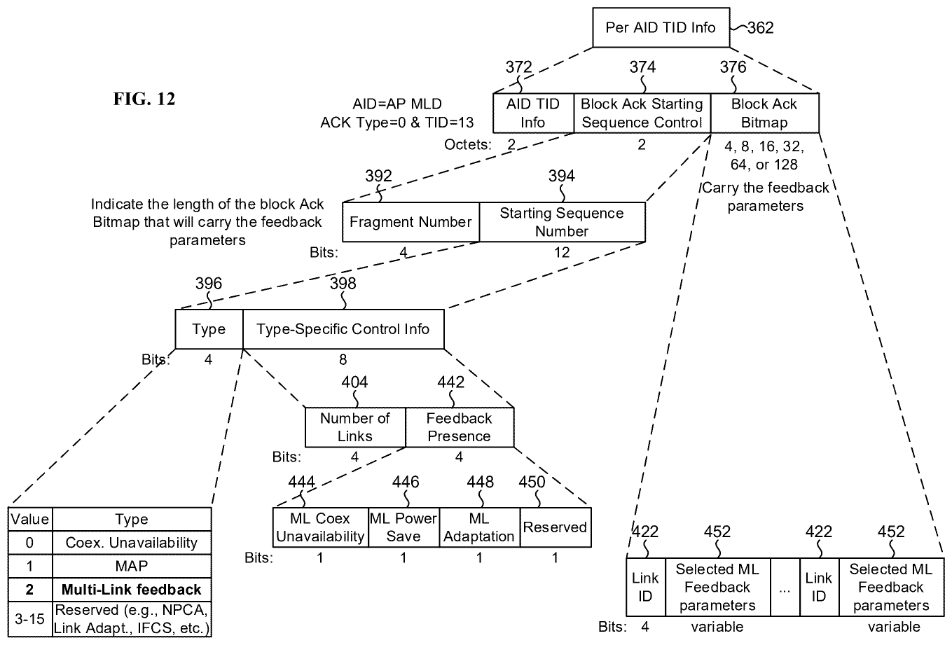

In some embodiments as shown in FIG. 12, if the Type field 396 indicates Multi-Link feedback, the eight-bit Type-Specific Common Control Info field 398 may comprise four (4) bits to indicate the number of links whose information will be fed back (denoted a Number of Links subfield 404) and four (4) bits to indicate the feedback presence (denoted a Feedback Presence subfield 442). For example, the Feedback Presence subfield 442 may comprise a one-bit Multi-Link Coexistence Unavailability Present subfield 444 (indicating whether or not Multi-Link Coexistence Unavailability is present), a one-bit Multi-Link dynamic Power Save Present subfield 446 (indicating whether or not Multi-Link dynamic Power Save is present), a one-bit Multi-Link Adaptation Present subfield 448 (indicating whether or not Multi-Link Adaptation is present), and a reserved bit 450.

In these embodiments, based on the selected type and the selected feedback parameters to be present, the Block ACK Bitmap subfield 376 is reused to include the control information parameters 452 for the selected control or feedback information type.

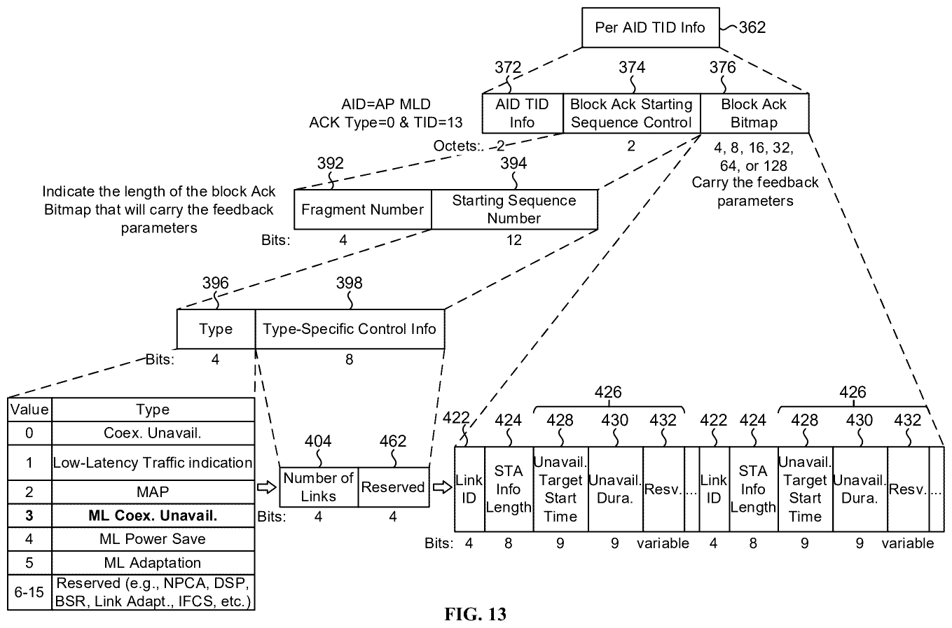

In above embodiments, the Type subfield 396 is used for indicating Coexistence Unavailability, MAP coordination, and Multi-Link Feedback. In some embodiments as shown in FIG. 13, the Type subfield 396 may be used for indicating other types of control or feedback information as well. TABLE 5 shows an example of the values of the Type subfield 396 located in, for example, the first four (4) bits of the Starting Sequence Number 394.

TABLE 5

| Value | Type |
|---|---|
| 0 | Coexistence Unavailability |
| 1 | Low-Latency Traffic Indication |
| 2 | MAP Coordination |
| 3 | Multi-Link Coexistence Unavailability |
| 4 | Multi-Link Power Save |
| 5 | Multi-Link Adaptation |
| 6-15 | Reserved (which can be used for NPCA, |
| | DPS, BSR, Link Adaptation, IFCS, and/ |
| | or the like) |

By using different type values to indicate Multi-Link Adaptation, Multi-Link Unavailability, Multi-Link Dynamic Power Save, and/or the like, as indicated in TABLE 5, the eight-bit Type-Specific Common Control Info field 398 may dedicate four (4) bits to indicate the number of links whose information is to be fed back (denoted a Number of Links subfield 404), and four (4) bits are kept reserved or utilized for other common information (denoted a Reserved subfield 462).

Based on the selected type (for example, Multi-Link adaptation, Multi-link Unavailability, Multi-Link Dynamic Power Save, or the like), the Block ACK Bitmap subfield 376 is reused to include a Link ID 422 (four (4) bits) for indicating which link's feedback is reported, an STA Info Length 424 (eight (8) bits) for indicating the length of the feedback parameters reported for the specific link, and the control or feedback information parameters 426 for the selected control or feedback information type.

For example, as shown in FIG. 13, if the selected type is Multi-Link Coexistence Unavailability, the Block ACK Bitmap subfield 376 is reused to include the Multi-Link Coexistence Unavailability parameters for each link or affiliated STA 112 such as Unavailability Start Time 428, Unavailability Duration 430, and optionally other information 432 for each link or affiliated STA whose feedback is reported.

In a similar embodiment, the Type subfield 396 (located in, for example, the first four (4) bits of the Starting Sequence Number 394) is used for indicating various types of control or feedback information as shown in TABLE 6.

TABLE 6

| Value | Type |
|---|---|
| 0 | Coexistence Unavailability |
| 1 | MAP Coordination |
| 2 | Multi-Link Coexistence Unavailability |
| 3 | Multi-Link Power Save |
| 4 | Multi-Link Adaptation |
| 5-15 | Reserved (which can be used for NPCA, |
| | DPS, BSR, Low-Latency Traffic indication, |
| | Link Adaptation, IFCS, and/or the like) |

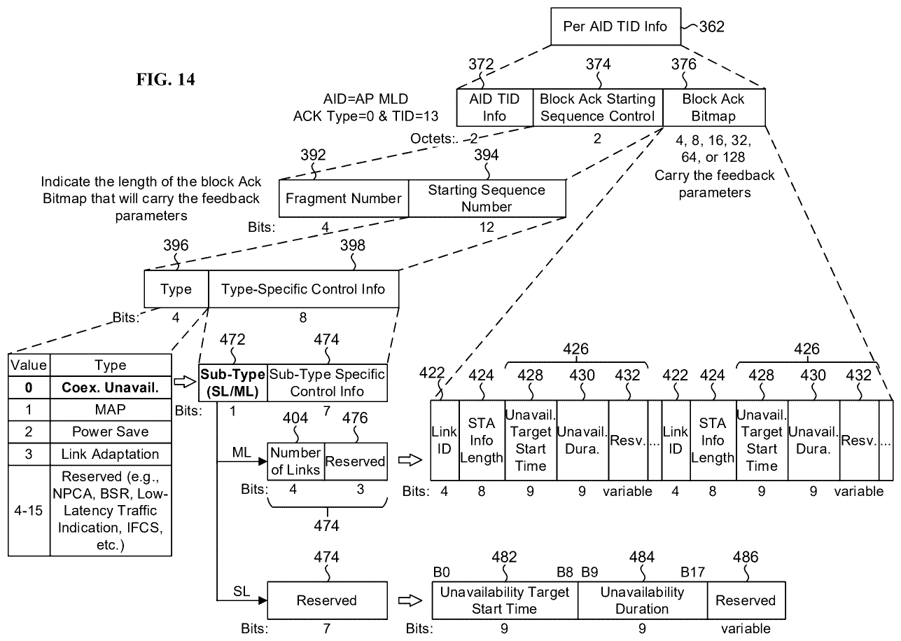

FIG. 14 is a schematic diagram showing the structure of the Per AID TID Info field 362, according to some embodiments of this disclosure. Table 7 shows an example of the values of the Type subfield 396 located in, for example, the first four (4) bits of the Starting Sequence Number 394:

TABLE 7

| Value | Type |
|---|---|
| 0 | Coexistence Unavailability |
| 1 | Low-Latency Traffic Indication |
| 2 | MAP Coordination |
| 3 | Power Save |
| 4 | Link Adaptation |
| 5-15 | Reserved (which can be used for NPCA, |
| | DPS, BSR, Link Adaptation, IFCS, |
| | and/or the like) |

If the Type subfield 396 has a value between zero (0) and four (4) to indicate Coexistence Unavailability, Low-Latency Traffic Indication, MAP Coordination, Dynamic Power Save, or Link Adaptation, as indicated in TABLE 7, the eight-bit Type-Specific Common Control Info field 398 comprises a one-bit Sub-Type field 472 and a seven-bit Sub-Type Specific Control Info field 474.

The value of the Sub-Type field 472 indicates a Single-Link (SL) or Multi-Link (ML) operation. Based on the selected type (for example, Link Adaptation, Link Unavailability, Link Dynamic Power Save, and/or the like) and the value of the Sub-Type field 472 (that is, the single-link or multi-link operation indication) in the Type-Specific Common Control Info subfield 398, the Block ACK Bitmap subfield 376 is reused to include the single-link or multi-link control or feedback information parameters for the selected control or feedback information type).

For example, a value zero (0) of the Sub-Type field 472 indicates a single link operation and the seven-bit Sub-Type Specific Control Info field 474 may be kept reserved or utilized for other common information. Accordingly, if the selected type is Coexistence Unavailability (that is, Type subfield 396 has a value of zero (0)), the Block Ack Bitmap subfield 376 may indicate the Unavailability Target Start Time 482, Unavailability Duration 484, and comprise some reserved bits 486.

On the other hand, a value one (1) of the Sub-Type field 472 indicates a multi-link operation. Then, four (4) bits of the Sub-Type Specific Control Info field 474 may be used to indicate the number of links' information being fed back (denoted a Number of Links subfield 404), and three (3) bits of the Sub-Type Specific Control Info field 474 may be kept reserved or utilized for other common information (476). Accordingly, if the selected type is Coexistence Unavailability, the Block Ack Bitmap subfield 376 may indicate the Unavailability Target Start Time 428 and Unavailability Duration 430 for each link as described above.

In some embodiments, Multi-Link Basic Element (of link (re)configuration (where “(re)configuration” represents “configuration” or “reconfiguration”) request, link (re)configuration response, and/or link (re)configuration notify action frames) may be used for Multi-Link Coexistence Unavailability Feedback.

In the (re)configuration request/response/notify action frame, the non-AP STA MLD 312 may indicate the Coexistence Unavailability for each affiliated STA 112 within the Multi-link Basic Element exchanged during the (re)association phase. In these embodiments, the IDC Dynamic Coexistence Unavailability Reporting feature may be enabled for MLDs by indicating the support of this feature in the Multi-Link Basic Element.

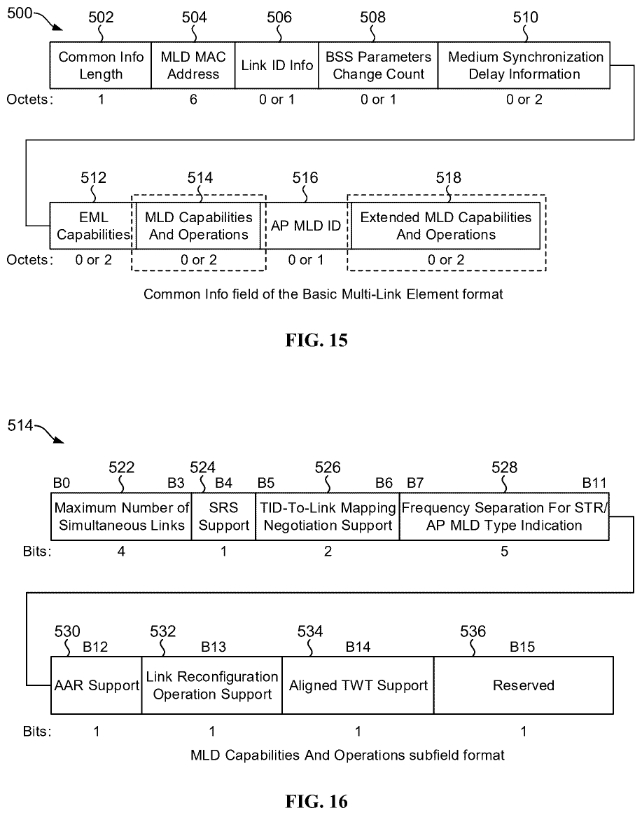

FIG. 15 is a schematic diagram showing the structure of the Common Info field 500 of the Basic Multi-Link Element, which comprises a Common Info Length subfield 502, an MLD Medium Access Control (MAC) Address subfield 504, a Link Identifier (ID) subfield 506, a BSS Parameters Change Count subfield 508, a Medium Synchronization Delay Information subfield 510, an Enhanced Multi-Link (EML) Capabilities subfield 512, an MLD Capabilities And Operations subfield 514, an AP MLD ID subfield 516, and an Extended MLD Capabilities And Operations subfield 518.

In these embodiments, the MLD Capabilities And Operations subfield 514 or more preferably the Extended MLD Capabilities And Operations subfield 518 may be used to indicate the support of the Dynamic Unavailability Operation (DUO) feature, which means that DUO is enabled and affiliated STAs 112 are allowed to report their Coexistence Unavailability periods.

For example, as shown in FIG. 16, the conventional MLD Capabilities And Operations subfield 514 comprises a four-bit Maximum Number of Simultaneous Links subfield 522, a one-bit Single Response Scheduling (SRS) Support subfield 524, a two-bit TID-To-Link Mapping Negotiation Support subfield 526, a five-bit Frequency Separation For STR/AP MLD Type Indication subfield 528, a one-bit AP Assistance Request (AAR) Support subfield 530, a one-bit Link Reconfiguration Operation Support subfield 532, a one-bit Aligned Target Wake Time (TWT) Support subfield 534, and a one-bit reserved subfield 536.

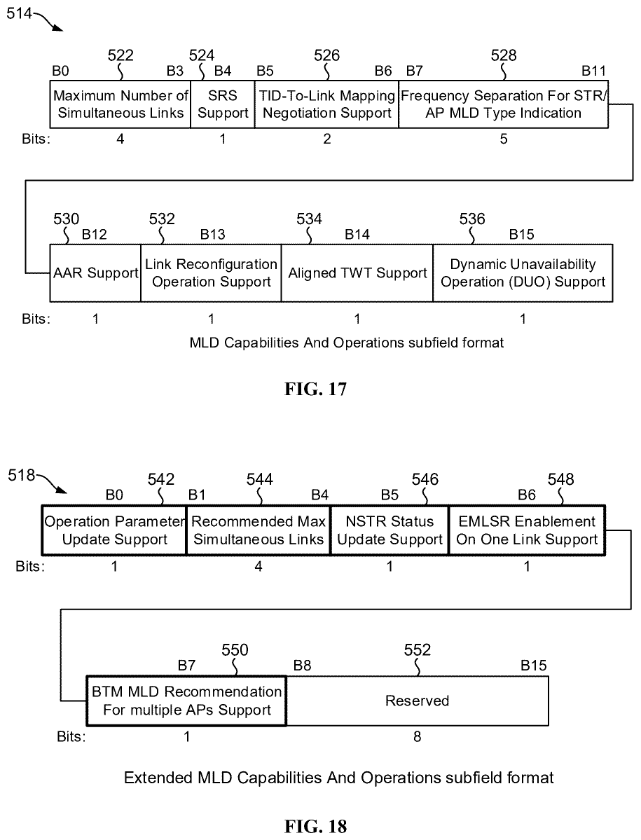

In some embodiments as shown in FIG. 17, the reserved bit 536 (that is, B15) within the MLD Capabilities And Operations subfield 514 may be used to indicate the DUO support.

FIG. 18 shows the structure of the conventional Extended MLD Capabilities And Operations subfield 518, which comprises a one-bit Operation Parameter Update Support subfield 542, a four-bit Recommended Max Simultaneous Links subfield 544, a one-bit Non-Simultaneous Transmit And Receive (NSTR) Status Update Support subfield 546, a one-bit Enhanced Multi-Link Single Radio (EMLSR) Enablement On One Link Support subfield 548, a one-bit BSS Transition Management (BTM) MLD Recommendation For multiple APs Support subfield 550, and an eight-bit reserved field 552.

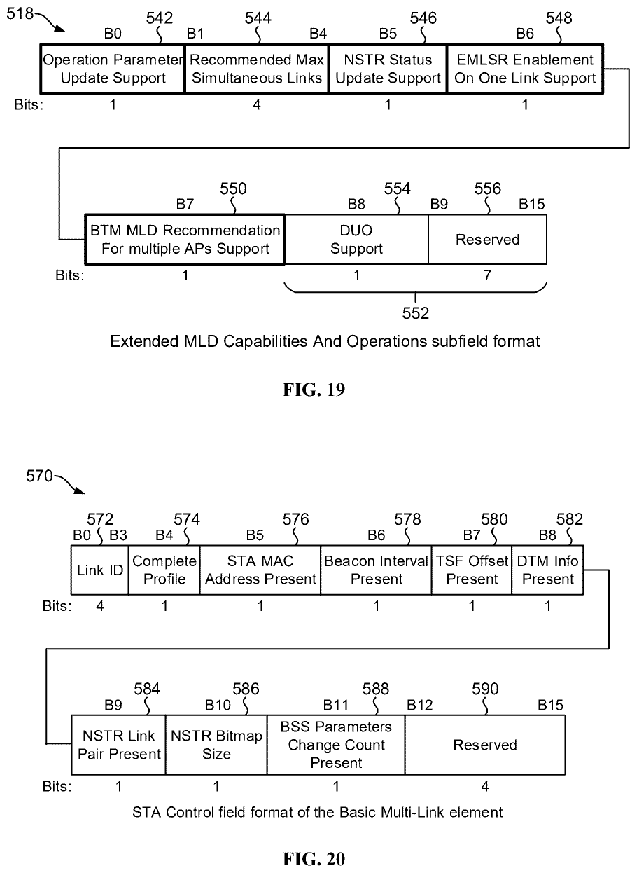

In some embodiments as shown in FIG. 19, it may be preferable to utilize any reserved bit from B8 to B15, for example, B8 within the Extended MLD Capabilities And Operations subfield 518, as a DUO Support subfield 554 to indicate the DUO support. The other seven bits 556 (for example, B9 to B15, may be reserved.

FIG. 20 is a schematic diagram showing the structure of the STA Control field 570 of the Multi-Link Basic Element, which comprises a four-bit Link ID subfield 572, a one-bit Complete Profile subfield 574, a one-bit STA MAC Address Present subfield 576, a one-bit Beacon Interval Present subfield 578, a one-bit Timing synchronization function (TSF) Offset Present subfield 580, a one-bit Delivery Traffic Indication Map (DTIM) Info Present subfield 582, a one-bit NSTR Link Pair Present subfield 584, a one-bit NSTR Bitmap Size subfield 586, a one-bit BSS Parameters Change Count Present subfield 588, and a four-bit reserved subfield 590 (bits B12 to B15).

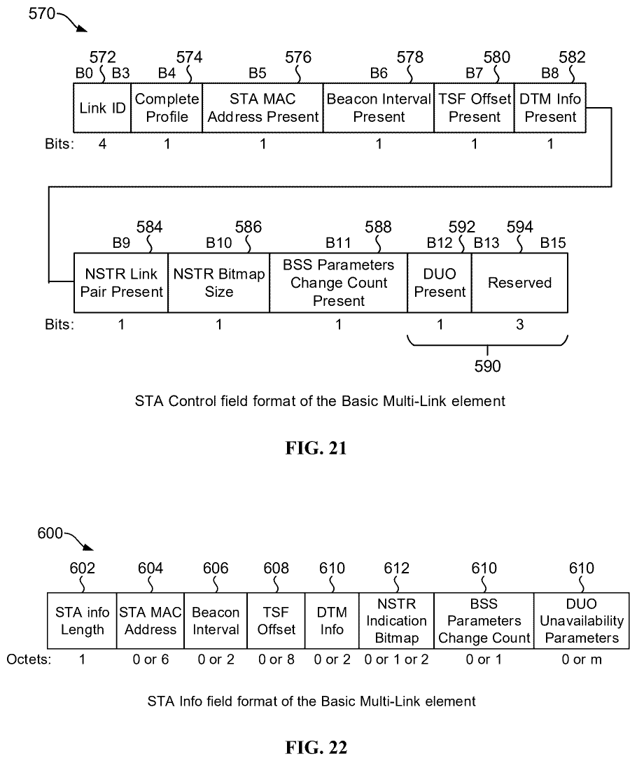

In some embodiments, if DUO is enabled via the MLD Capabilities And Operations subfield 514 or (more preferably) via the Extended MLD Capabilities And Operations subfield 518 of the Common Info field 500 of the Basic Multi-Link Element, then, as shown in FIG. 21, any reserved bit of the four-bit reserved subfield 590 (B12-B15), such as B12, of the STA Control field 570 of the Multi-Link Basic Element may be used to indicated DUO parameters present (denoted DUO Present 592) for each affiliated STA 112.

As shown in FIG. 22, when the value of the DUO Present subfield is set to one (1), the DUO Coexistence Unavailability parameters are present in the STA Info field 600 of the Multi-Link Basic Element (denoted as DUO Unavailability Parameters 610).

In some embodiments, Multi-Link Reconfiguration Elements (of link (re)configuration request, link (re)configuration response, and/or link (re)configuration notify action frames) may be used for reporting the Multi-Link In-Device Coexistence Unavailability Feedback.

In these embodiments, the AP MLD 302 sends an ICF 322 (which acts as a Multi-Link Configuration Request frame) to a non-AP STA MLD 312, requesting its unavailability period. In response, the non-AP STA MLD 312 sends an ICR 324 (which acts as a Multi-Link Configuration Response frame) providing the unavailability period for each affiliated STA 112, wherein the Coexistence Unavailability information for each affiliated STA 112 may be included within the Multi-Link Reconfiguration Element, as discussed below. Additionally, the non-AP STA MLD 312 may send unsolicited Multi-Link Coexistence Unavailability report by transmitting a Multi-Link Configuration Notify frame.

In these embodiments, the IDC Dynamic Coexistence Unavailability Reporting feature can be enabled for multi-link devices by indicating the support of this feature in the Multi-Link Reconfiguration Element.

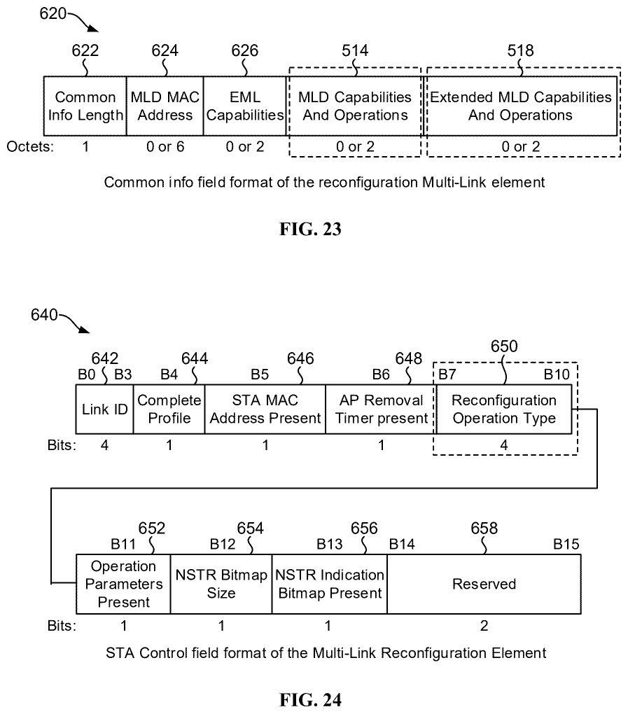

FIG. 23 is a schematic diagram showing the structure of the Common Info field 620 of the Multi-Link Reconfiguration Element in these embodiments. As shown, the Common Info field 620 of the Multi-Link Reconfiguration Element comprises a one-byte Common Info Length subfield 622, an optional six-byte MLD MAC Address subfield 624, an optional two-byte EML Capabilities subfield 626, an optional two-byte MLD Capabilities And Operations subfield 514, and an optional two-byte Extended MLD Capabilities And Operations subfield 518, wherein the MLD Capabilities And Operations subfield 514 or more preferably the Extended MLD Capabilities And Operations subfield 518 may be used to indicate the support of the DUO feature, which means that DUO is enabled and affiliated STAs 112 are allowed to report their Coexistence Unavailability periods.

The MLD Capabilities And Operations subfield 514 of the Multi-Link Reconfiguration Element has the same structure of that of the Basic Multi-Link Element (see FIG. 15) and is denoted using the same reference numeral. Similar to the embodiments shown in FIGS. 16 and 17, the conventionally reserved bit B15 within the MLD Capabilities And Operations subfield 514 of the Multi-Link Reconfiguration Element may be similarly used to indicate the DUO Support 536.

The Extended MLD Capabilities And Operations subfield 518 of the Multi-Link Reconfiguration Element has the same structure of that of the Basic Multi-Link Element (see FIG. 15) and is denoted using the same reference numeral. Similar to the embodiments shown in FIGS. 18 and 19, any of the conventionally reserved bits of B8-B15, such as bit B8, within the Extended MLD Capabilities And Operations subfield 518 of the Multi-Link Reconfiguration Element may be used to indicate the DUO Support 554.

FIG. 24 is a schematic diagram showing the structure of the STA Control field 640 of the Multi-Link Reconfiguration Element, which comprises a four-bit Link ID subfield 642, a one-bit Complete Profile subfield 644, a one-bit STA MAC Address Present subfield 646, a one-bit AP Removal Timer present subfield 648, a four-bit Reconfiguration Operation Type subfield 650, a one-bit Operation Parameters Present subfield 652, a one-bit NSTR Bitmap Size subfield 654, a one-bit NSTR Indication Bitmap present subfield 656, and a two-bit reserved subfield 658 (bits B14 and B15).

In some embodiments, the Reconfiguration Operation Type subfield 650 may take the values shown in TABLE 8, wherein one of the conventionally reserved values of the Reconfiguration Operation Type subfield 650 (such as value 5) may be used in these embodiments for indicating that this Multi-Link Reconfiguration Element is for DUO Unavailability Feedback (that is, for IDC Dynamic Coexistence Unavailability Reporting).

TABLE 8

| Value | Name |
|---|---|
| 0 | AP Removal |
| 1 | Operation Parameter Update |
| 2 | Add Link |
| 3 | Delete Link |
| 4 | NSTR Status Update |
| 5 | Feedback |
| 6-15 | Reserved |

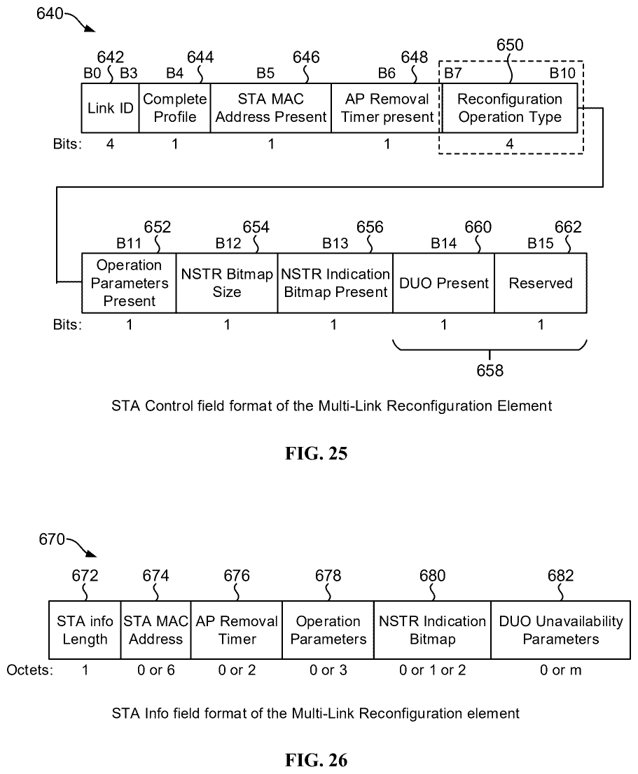

In some embodiments, if DUO is enabled via the MLD Capabilities And Operations subfield 514 of the Multi-Link Reconfiguration Element or more preferably the Extended MLD Capabilities And Operations subfield 518 of the Multi-Link Reconfiguration Element of the Common Info field 620 of the Multi-Link Reconfiguration Element, then, as shown in FIG. 25, any reserved bit of the two-bit reserved subfield 658 (B14-B15), such as B14, of the STA Control field 640 of the Multi-Link Reconfiguration Element may be used to indicated DUO Parameters Present (denoted DUO Present 660) for each affiliated STA 112.

FIG. 26 is a schematic diagram showing the structure of the STA Info field 670 of the Multi-Link Reconfiguration Element, which comprises a one-byte STA info Length subfield 672, an optional six-byte STA MAC Address subfield 674, an optional two-byte AP Removal Timer subfield 676, an optional three-byte Operation Parameters subfield 678, an optional one- or two-byte NSTR Indication Bitmap subfield 680, and a m-byte (m being an integer) DUO Unavailability Parameters subfield 682 for storing the DUO Coexistence Unavailability parameters, when the value of the DUO Present subfield 660 is set to one (1).

For instance, The AP MLD 302 sends a Multi-Link Configuration Request frame to a non-AP STA MLD 312, requesting its unavailability period. Within this Multi-Link Configuration Request, the AP MLD 302 includes a Multi-Link Reconfiguration Element with the value of the Reconfiguration Operation Type subfield 650 of the STA Control field 640 is set to, for example, five (5), to indicate that DUO Unavailability feedback is solicited.

In response, the non-AP STA MLD 312 sends a Multi-Link Configuration Response frame, providing the unavailability period for each affiliated STA 112 within the STA Info field 670 of the Multi-Link Reconfiguration Element, carried by the Multi-Link Configuration Response frame.

Those skilled in the art will appreciate that, in various embodiments, the location of the subfields within the Block Ack Starting Sequence Control field and Block Ack Bitmap field may vary.

In above description, DL transmission is described as an example for leveraging multi-link unavailability reporting in MLOs. However, those skilled in the art will appreciate that, in various embodiments, multi-link unavailability reporting may also be employed for UL transmission in MLOs.

The multi-link unavailability reporting methods disclosed herein have various advantages and technical effects.

For example, the multi-link unavailability reporting methods disclosed herein enable non-AP STA MLDs 312 to report unavailability across multiple links, thereby improving coordination of transmission windows and reducing unnecessary retransmissions, and enhancing reliability. The multi-link unavailability reporting methods disclosed herein use enhanced transmission scheduling and conflict resolution, which improves transmission efficiency by managing transmission opportunities (TXOP) across multiple links, thereby reducing conflicts and retransmissions, and enhancing overall network performance. Moreover, the multi-link unavailability reporting methods disclosed herein provide scalability and flexibility across frequency bands, which ensure scalable mechanisms across both lower-frequency bands (such as sub-7.25 GHz bands) and higher-frequency bands (such as 42 GHz to 71 GHZ), thereby supporting future WI-FI® developments and improving performance across diverse environments.

### C. Acronyms, Abbreviations, and Definition of Some Terms

| | Acronym/Abbreviation/ |
|---|---|
| Full Name | Initialism |
| Access Category | AC |
| Access Point | AP |
| AID | Associated Identifier |
| Basic Service Set | BSS |
| Block Acknowledgement | BA |
| Block Acknowledgement Request | BAR |
| Buffer Status Report Poll | BSRP |
| Clear-to-Send | CTS |
| Coordinated Beamforming | Co-BF |
| Coordinated Spatial Reuse | Co-SR |
| Coordinated Time Division Multiple Access | Co-TDMA |
| Coordinated Orthogonal Frequency Division | Co-OFDMA |
| Multiple Access | |
| Coordinated restricted Target Wake-up Time | Co-r-TWT |
| Downlink | DL |
| Enhanced Distributed Channel Access | EDCA |
| Initial Control Frame | ICF |
| Initial Control Response | ICR |
| Link Adaptation | LA |
| Multi-AP | MAP |
| Multi-AP Coordination | MAPC |
| Multi-Stations Block Acknowledgement | Multi-STA BA |
| Multi-User Block Acknowledgement Request | MU-BAR |
| Multi-User Request-to-Send | MU-RTS |
| Multi-Link | ML |
| Multi-Link Operation | MLO |
| Non-Primary Channel Access | NPCA |
| Overlapping Basic Service Set | OBSS |
| Physical | PHY |
| Reception | RX |
| Signal-to-Interference-plus-Noise-Ratio | SINR |
| Service Period | SP |
| Station | STA |
| Target Beacon Transmission Time | TBTT |
| Traffic Identifier | TID |
| Transmission | TX |
| Transmission Opportunity | TXOP |
| To Be Defined | TBD |
| Ultra-High Reliability | UHR |
| Uplink | UL |
| Wireless LAN | WLAN |

Herein, the terms “field” and “subfield” are used for describing frame structures logically, wherein a field may comprise a plurality of subfields, and a subfield may comprise a plurality of other subfields. However, those skilled in the art will appreciate that terms “field” and “subfield” may be used interchangeably. For example, it may be described that a field may comprise a plurality of other fields. Although not used very often, it may be described that a subfield may comprise a plurality of fields. In all these descriptions, those skilled in the art will readily understand that a field or a subfield is a section or segment of information, which may be partitioned into a plurality of (smaller) sections or segments of information. While above description may include expressions such as “a frame includes a field, and the field further includes a plurality of subfields”, or the like, those skilled in the art will readily understand that such expressions are equivalent to the expressions such as “the frame includes the plurality of subfields”, or the like, where the term “field” may be ignored.

The terms “first”, “second”, and “third” are used for descriptive purposes only, and are not to be construed as indicating or implying the relative importance or implicitly indicating the number of indicated technical features. Thus, a feature defined with “first”, “second”, or “third” may explicitly or implicitly include one or more of the features. In addition, unless otherwise specified, ordinal numbers such as “first” and “second” in implementations of this application are used to distinguish between a plurality of objects, and are not used to limit a sequence, a time sequence, priorities, or importance of the plurality of objects.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example implementation, should be understood to mean that the value, condition or characteristic is defined within tolerances that are acceptable for the proper operation of the example implementation for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different implementations of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” may indicate an “or” relationship between associated objects, or may indicate an “and/or” relationship thereof, depending on the context. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C.

Herein, the term “preconfigured” (for example, a “preconfigured” item such as a “preconfigured” parameter) refers to an item configured by a suitable apparatus before a certain even occurs.

Although in above examples, the adaptive information retrieval method is performed by the computer network system 100, in some embodiments, no computer network system 100 is required, and the methods disclosed herein is performed by a single computing device 102 or 104.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

A person skilled in the art should understand that implementations of this application may be provided as a method, an apparatus (or system), computer-readable storage medium, or a computer program product. Therefore, this application may use a form of a hardware-only implementation, a software-only implementation, or an implementation with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

It is clear that a person skilled in the art can make various modifications and variations to this application without departing from the scope of this disclosure. More specifically, although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. This disclosure is intended to cover these modifications and variations of this application provided that they fall within the scope of protection defined by the following claims and their equivalent technologies.

What is claimed is:

1. A communication method comprising:
transmitting or receiving a first frame for indicating one or more unavailability time periods of a plurality of links; and
receiving or transmitting a plurality of data frames via the plurality of links using at least one of the one or more unavailability time periods.

2. The method of claim 1, wherein the first frame is a multi-STA block acknowledgement (multi-STA Block ACK) frame conveying control or feedback information including the one or more unavailability time periods, or
the first frame comprises a Multi-Link Element conveying the one or more unavailability time periods, the Multi-Link Element being a Basic Multi-Link Element or a Multi-Link Reconfiguration Element.

3. The method of claim 2, wherein the first frame is the multi-STA Block ACK frame;
wherein the first frame comprises a Per Associated Identifier (AID) Traffic Identifier (TID) Info field;
wherein the Per AID TID info field comprises a Type field and a Block Ack Bitmap field;
wherein the Type field is for indicating that the type of the control or feedback information is multi-link feedback, or indicating that the type of the control or feedback information is multi-link coexistence unavailability, or indicating that the type of the control or feedback information is coexistence unavailability; and
wherein the Block Ack Bitmap field is for conveying the control or feedback information including the one or more unavailability time periods.

4. The method of claim 3, wherein the Per AID TID info field further comprises a Sub-Type field; and
wherein the Type field indicates that the type of the control or feedback information is the multi-link feedback and the Sub-Type field indicates that the type of multi-link feedback is multi-link coexistence unavailability, or the Type field indicates that the type of the control or feedback information is the coexistence unavailability and the Sub-Type field indicates that the coexistence unavailability is single-link coexistence unavailability or multi-link coexistence unavailability.

5. The method of claim 2, wherein the first frame comprises the Multi-Link Element;
wherein the Multi-Link Element comprises:
a Common Info field,
a STA Control field, and
a STA Info field;
wherein a Multi-Link Devices (MLD) Capabilities And Operations subfield or an Extended MLD Capabilities And Operations subfield of the Common Info field comprises a Dynamic Unavailability Operation (DUO) Support field indicating that the one or more unavailability time periods are allowed to report;
wherein the STA Control field comprises a DUO Present field indicating the presence of DUO support field; and
wherein the STA Info field comprises the one or more unavailability time periods.

6. A communication apparatus comprising:
one or more processors functionally coupled to one or more non-transitory computer-readable storage media storing computer-executable instructions;
wherein the instructions, when executed by the one or more processors, cause the apparatus to perform actions comprising:
transmitting or receiving a first frame indicating one or more unavailability time periods of a plurality of links; and
receiving or transmitting a plurality of data frames via the plurality of links using at least one of the one or more unavailability time periods.

7. The communication apparatus of claim 6, wherein the first frame is a multi-STA block acknowledgement (multi-STA Block ACK) frame conveying control or feedback information including the one or more unavailability time periods, or the first frame comprises a Multi-Link Element conveying the one or more unavailability time periods, the Multi-Link Element being a Basic Multi-Link Element or a Multi-Link Reconfiguration Element.

8. The communication apparatus of claim 7, wherein the first frame is the multi-STA Block ACK frame;
wherein the first frame comprises a Per Associated Identifier (AID) Traffic Identifier (TID) Info field;
wherein the Per AID TID info field comprises a Type field and a Block Ack Bitmap field;
wherein the Type field is for indicating that the type of the control or feedback information is multi-link feedback, or indicating that the type of the control or feedback information is multi-link coexistence unavailability, or indicating that the type of the control or feedback information is coexistence unavailability; and
wherein the Block Ack Bitmap field is for conveying the control or feedback information including the one or more unavailability time periods.

9. The communication apparatus of claim 8, wherein the Per AID TID info field comprises a Sub-Type field; and
wherein the Type field indicates that the type of the control or feedback information is the multi-link feedback and the Sub-Type field indicates that the type of multi-link feedback is multi-link coexistence unavailability, or the Type field indicates that the type of the control or feedback information is the coexistence unavailability and the Sub-Type field indicates that the coexistence unavailability is single-link coexistence unavailability or multi-link coexistence unavailability.

10. The communication apparatus of claim 7, wherein the first frame comprises the Multi-Link Element;
wherein the Multi-Link Element comprises:
a Common Info field,
a STA Control field, and
a STA Info field;
wherein a Multi-Link Devices (MLD) Capabilities And Operations subfield or an Extended MLD Capabilities And Operations subfield of the Common Info field comprises a Dynamic Unavailability Operation (DUO) Support field indicating that the one or more unavailability time periods are allowed to report;
wherein the STA Control field comprises a DUO Present field indicating the presence of DUO support; and
wherein the STA Info field comprises the one or more unavailability time periods.

11. One or more non-transitory computer-readable storage media comprising computer-executable instructions, wherein the instructions, when executed by one or more processors, cause an apparatus to perform actions comprising:
transmitting or receiving a first frame for indicating one or more unavailability time periods of a plurality of links; and
receiving or transmitting a plurality of data frames via the plurality of links using at least one of the one or more unavailability time periods.

12. The one or more non-transitory computer-readable storage media of claim 11, wherein the first frame is carried via one of the plurality of links or a sub-7.25 gigahertz (GHz) frequency band.

13. The one or more non-transitory computer-readable storage media of claim 11, wherein the first frame is a multi-STA block acknowledgement (multi-STA Block ACK) frame conveying control or feedback information including the one or more unavailability time periods, or the first frame comprises a Multi-Link Element conveying the one or more unavailability time periods, the Multi-Link Element being a Basic Multi-Link Element or a Multi-Link Reconfiguration Element.

14. The one or more non-transitory computer-readable storage media of claim 13, wherein the first frame is the multi-STA Block ACK frame; and
wherein the first frame comprises a Per Associated Identifier (AID) Traffic Identifier (TID) Info field indicating the one or more unavailability time periods.

15. The one or more non-transitory computer-readable storage media of claim 14, wherein the Per AID TID info field comprises an AID11 field, an acknowledge (ACK) Type field, and a TID field; and
wherein values of the ACK Type field and the TID field indicate that the Per AID TID Info field is for conveying the control or feedback information.

16. The one or more non-transitory computer-readable storage media of claim 15, wherein the AID11 field has a value greater than 2007.

17. The one or more non-transitory computer-readable storage media of claim 14, wherein the Per AID TID info field comprises a Type field indicating that the type of the control or feedback information is multi-link feedback, or indicating that the type of the control or feedback information is multi-link coexistence unavailability, or indicating that the type of the control or feedback information is coexistence unavailability.

18. The one or more non-transitory computer-readable storage media of claim 17, wherein the Per AID TID info field comprises a Sub-Type field; and
wherein the Type field indicates that the type of the control or feedback information is the multi-link feedback and the Sub-Type field indicates that the type of multi-link feedback is multi-link coexistence unavailability, or the Type field indicates that the type of the control or feedback information is the coexistence unavailability and the Sub-Type field indicates that the coexistence unavailability is single-link coexistence unavailability or multi-link coexistence unavailability.

19. The one or more non-transitory computer-readable storage media of claim 14, wherein the Per AID TID info field comprises a Block Ack Bitmap field conveying the control or feedback information including the one or more unavailability time periods.

20. The one or more non-transitory computer-readable storage media of claim 13, wherein the first frame comprises a Multi-Link Element;
wherein the Multi-Link Element comprises:
a Common Info field,
a STA Control field, and
a STA Info field;
wherein a MLD Capabilities And Operations subfield or an Extended MLD Capabilities And Operations subfield of the Common Info field comprises a Dynamic Unavailability Operation (DUO) Support field indicating that the one or more unavailability time periods are allowed to report;
wherein the STA Control field comprises a DUO Present field indicating the presence of DUO support; and
wherein the STA Info field comprises the one or more unavailability time periods.
